(19) United States
(12) Patent Application Publication
(10) Pub. No.: US 2010/0273018 A1
(43) Pub. Date: Oct. 28, 2010

(54) AQUEOUS VINYL POLYMER COATING COMPOSITIONS

(75) Inventors: Jurgen SCHEERDER, Waalwijk (NL); Yvonne Wihelmina Smak, Waalwijk (NL); Gerardus Comelis Overbeek, Waalwijk (NL)

Correspondence Address: NIXON & VANDERHYE, PC, 901 NORTH GLEBE ROAD, 11TH FLOOR, ARLINGTON, VA, 22203, US

(73) Assignee: DSM IP Assets B.V.

(21) Appl. No.: 12/831,044

(22) Filed: Jul. 6, 2010

Related U.S. Application Data
(63) Continuation of application No. 11/632,120, filed on Feb. 1, 2007, now abandoned.

(30) Foreign Application Priority Data
Jul. 16, 2004 (GB) 0416166.7
Mar. 19, 2005 (GB) 0505667.6

(51) Int. Cl. B32B 27/08; C08K 5/24

(52) U.S. Cl. 428/516; 524/189; 524/192; 428/500

(57) ABSTRACT

Aqueous coating composition comprising (1) at least one vinyl polymer having a Mw≧15 k Da and a Tg≧0° C. formed from (i) 0.1 to 20 wt % of vinyl monomer(s) containing acid functional groups and (ii) 0 to 0.49 wt % of vinyl monomer(s) containing a carbonyl functional group(s) and (2) 0.01 to 10 wt % of at least one polyhydrazine compound B where said composition provides a film coating of König hardness ≧40 s.

This application is a continuation of commonly owned co-pending U.S. application Ser. No. 11/632,120, filed Jan. 11, 2007, which in turn is the national phase application under 35 USC §371 of PCT/EP2005/007294, filed Jul. 6, 2005, which designated the U.S. and claims priority to GB 0416166.7 and GB 0505667.6 filed Jul. 16, 2004 and Mar. 19, 2005, respectively, the entire contents of each of which are hereby incorporated by reference.

The present invention relates to certain aqueous coating compositions comprising at least one vinyl polymer and at least one polyhydrazine compound, the use of such compositions to provide coatings on certain polymer substrate surfaces and to a process for the production of such coating compositions.

The adhesion of coatings to the surfaces of polymer substrates (wherein the term “polymer substrate” herein includes a polymer film coating itself supported on a substrate and a stand-alone polymer film, sheet or other shaped article), is of great importance in industry. Particular polymer systems of interest for providing polymer substrates are alkyds and polyolefines (alkyds being fatty acid residue-containing polyesters). Adhesion to these surfaces is known to be promoted by the presence of polar groups at the polymer substrate surface.

The surface of an alkyd substrate is known to be polar in nature, and because of the effect of ultraviolet and visible radiation and moisture on the exposed alkyd substrate surface in use, this polarity increases in time (i.e. as the alkyd substrate is aged). The effect of such increased polarity at the surface would be expected to be two-fold; firstly it would be expected to improve wetting, and secondly ought to create a favourable condition for strong adhesion thereto. In practice, however, while dry adhesion (i.e. adhesion under dry ambient conditions) to aged alkyd substrate surfaces is generally good, wet adhesion (i.e. adhesion under wet or high relative humidity ambient conditions) thereto is generally poor.

It is well known in the art to improve the adhesion to substrate surfaces in general by first roughening them with an abrasive material (such as sandpaper or alumina impregnated paper, or with abrasive beads and particles as in sandblasting; herein such surface roughening is generically termed “sanding” for convenience). While sanding is known to have a limited positive effect on the wet adhesion, sanding is a laborious and costly procedure and is desirably omitted if at all possible. As mentioned above, dry adhesion to an aged alkyd substrate surface is generally good, this being with or without pre-sanding. Nevertheless, wet adhesion to aged alkyd substrate surfaces still remains a considerable weakness since alkyd-based paint systems are much used in the joinery and decorative market segments, and it is therefore highly desirable to achieve good wet adhesion on unsanded aged alkyd substrate surfaces. Additionally wet adhesion to aged alkyds, especially when used in the joinery market and the hardness and blocking of any resultant coating are important requirements.

Polyolefines such as polypropylene and polyethylene are widely used for the provision of various substrates, but adhesion to the surfaces of such substrates is very difficult to achieve because of their very low surface energy, indicating the absence of polar groups. One way to increase the surface energy is by plasma or corona treatment of the polyolefine surface, thereby resulting, it is hoped, in improved wetting and adhesion thereto. For label coatings, inks are normally printed directly onto the surfaces of polyolefine substrates such as corona treated polypropylene; however, few water-based and/or UV-curing inks give adequate adhesion to such corona treated polypropylene surfaces. The use of an intermediate polymer coating with good adhesion to both the treated polypropylene surface and the ink (i.e. a primer coating) makes it possible to use a wider variety of inks, in particular uv-curing inks, which do not adhere well to un-primed corona-treated polypropylene.

Wet adhesion to aged alkyd film coatings is typically improved by using cyclic ureido compounds such as described in GB 2086917, U.S. Pat. No. 4,104,220, U.S. Pat. No. 4,151,142, EP 1167356, U.S. Pat. No. 5,496,907, WO 97/49676, WO 97/49685, WO 97/49686 and WO 97/49687. Other N-functional compounds have also been used (to provide polymer-based hydrazine groups) in order to improve wet adhesion to aged alkyd surfaces. The use of diacetone diacrylamide in combination with adipic acid dihydrazide to improve wet adhesion has been described in U.S. Pat. No. 4,176,103. The combination of acetoacetoxy ethyl methacrylate and dimethylaminoethyl methacrylate has been described in EP 663927.

EP 148386 describes the improvement of dry adhesion of polymer adhesives to corona treated polyolefine substrates by the addition of dihydrazides to polymer adhesives of low hardness and typically low glass transition temperature (Tg) of between about −38° C. and 10° C.; such sticky adhesives would not be useful for non-sticky (after drying) coatings applications in which high hardness and good antiblocking properties are required. The adhesion of inks to substrates primed with these polymer adhesive dihydrazide blends is not disclosed.

EP 130336 describes binders for aqueous inks which contain 0.5 to 10 wt % of at least one co-polymerisable ketone or aldehyde compound and a water soluble aliphatic dihydrazide compound. These binders are claimed to improve the wet and dry adhesion to pre-treated polyolefine substrates.

EP 296487 describes blends of two different polymers of which at least one of the two components must contain a carbonyl functionality.

U.S. Pat. No. 6,251,973 describes a composition including a polymer having at least one functional groups, a silane and a hydrazide. The functional groups provide a site for attachment of the hydrazide groups to the polymer.

EP 765922 describes the use of a composition comprising an acrylate polymer with functional groups reactive with an added crosslinking agent, a crosslinking agent selected from a polyisocyanate, aminoplast, carbamates and mixtures thereof, and a hydrazide. The acrylic polymer does not need to contain a carbonyl functional group.

Surprisingly, we have found that when polyhydrazine compounds are incorporated in certain vinyl polymer coating compositions to provide coatings of high hardness, both the wet adhesion of such coatings to aged alkyd polymer surfaces and the adhesion (wet and dry) to for example corona treated polyolefine surfaces is significantly improved. Even more surprisingly, we have found that at least one vinyl polymer of such compositions in which the polyhydrazine compounds are included can comprise little or no carbonyl functionality reactive with the polyhydrazine compounds. This provides significant cost or safety benefits since reactive carbonyl functional monomers providing such carbonyl functionality such as acrolein may be expensive or may have negative toxicological effects.

The present invention therefore offers a more economic and practical alternative to achieve improved wet adhesion to unsanded aged alkyds and adhesion (wet or dry) to corona treated polyolefines. Moreover, despite the addition of hydrophilic compounds such as polyhydrazines the improved wet adhesion is not compromised by a reduction in water resistance. Still further, the coatings formed by the invention compositions exhibit good hardness and block resistance.

In particular it is found that the adhesion (wet or dry) to treated biaxially oriented polypropylene (BOPP) substrates is significantly improved when using the invention compositions. Moreover, not only the adhesion to polyolefines such as BOPP is improved but also the adhesion of various inks to polyolefines (e.g. BOPP) primed with the invention composition is improved. Polymers of this invention are not directed to sticky adhesives applications (as described in the prior art) but are applicable for inks and hard coating applications because this improvement in adhesion is accompanied with high hardness and good blocking properties.

According to the present invention there is provided an aqueous coating composition comprising:

(1) an aqueous dispersion of at least one vinyl polymer A having weight average molecular weight (Mw) of at least 15 kDa and Tg of at least 0° C., wherein said at least one vinyl polymer A is formed from the polymerisation of:
(i) 0.1 to 20 wt % of at least one vinyl monomer containing an acid functional group(s);
(ii) 0 to 0.49 wt % of at least one vinyl monomer containing a carbonyl functional group(s); and
(iii) 99.9 to 80 wt % of another vinyl monomer(s) not comprised in (i) or (ii); where (i)+(ii)+(iii) add up to 100 wt %; and
   (2) 0.01 to 10 wt % of at least one polyhydrazine compound B based on the weight of said at least one vinyl polymer A; and wherein:
(a) said composition provides a film coating of König hardness 40 seconds; and
(b) the carbonyl functional groups in said composition, if any, are provided only by way of said monomer(s) of (ii).

For the purposes of the invention an “aqueous dispersion” of a vinyl polymer A, or an “aqueous composition” comprising it, means a dispersion, solution or composition comprising the polymer(s) in a liquid carrier medium of which water is the principle or only component (usually at least 50 wt %, more usually at least 80 wt % of the liquid carrier medium). Other components include organic solvent(s), in particular water-miscible organic solvent(s). The invention dispersion or composition will typically comprise colloidally dispersed polymer particles, i.e. will typically comprise an aqueous polymer emulsion (alternatively termed herein as an aqueous polymer latex).

Vinyl polymer A may be alkaline soluble but preferably vinyl polymer A has only partial or limited solubility in water. Low water solubility is defined herein as the vinyl polymer A being less than 50% by weight soluble in water throughout the pH range of from 2 to 10 as determined for example by a centrifuge test. The water solubility may be determined by adding vinyl polymer A to water to a dilution of 10% solids and subsequent adjustment of the pH within a range of from 2 to 10. The pH chosen should be the pH where vinyl polymer A is expected to be most soluble, for example often a pH of about 9 is suitable for anionic stabilised dispersions and a pH or about 2 is often suitable for cationic stabilised dispersions. The dispersion should then be centrifuged over 5 hours at 21000 rpm at 23±2° C. After centrifugation a sample of the supernatant liquid was taken and evaporated for 1 hour at 105° C. to determine the solids content of the supernatant liquid.

The water solubility percentage was calculated by dividing the amount of solids (g) of the supernatant by the total of amount of solids in the sample and multiplying by 100. Preferably vinyl polymer A is ≧40%, more preferably ≧30% most preferably ≧15% by weight soluble in water throughout the pH range of from 2 to 10. Preferably vinyl polymer A is an aqueous dispersion.

In the present invention the glass transition temperature To of a vinyl polymer A means that Tg as calculated according to the Fox equation (see later). Preferably said at least one vinyl polymer A has Tg of at least 20° C. and more preferably at least 40° C.

In the present invention, the weight average molecular weight Mw of a vinyl polymer A is determined by means of gel permeation chromatography (GPC) using a polystyrene standard for calibration. Preferably said at least one vinyl polymer A has Mw of at least 30 kDa, more preferably at least 95 kDa.

In a preferred embodiment of the invention, the following empirical relationship should apply with regard to the or each vinyl polymer A in the composition:

Tg+Mw≧55

where Tg is in degrees C. and Mw is in kDaltons (kDa). More preferably the relationship Tg+Mw≧70 applies and still more preferably the relationship Tg+Mw≧100 applies.

By a “vinyl polymer” is meant generally herein a polymer derived from the addition polymerisation (normally by a free-radical process) of at least one olefinically unsaturated monomer. By a “vinyl monomer” is therefore meant generally herein an olefinically unsaturated monomer capable of undergoing free-radical polymerisation.

Examples of vinyl monomers suitable for the provision of (iii) include conjugated (optionally substituted) dienes; styrene and substituted styrenes; olefines such as ethylene or propylene; vinyl halides; vinyl esters such as vinyl acetate, vinyl propionate, vinyl laurate, and vinyl esters of versatic acid such as VeoVa™ 9 and VeoVa™ 10 (VeoVa is a trademark of Shell); heterocyclic vinyl compounds, dialkyl esters of mono-olefinically unsaturated dicarboxylic acids (such as di-n-butyl maleate and di-n-butyl fumarate; vinyl ethers; and, in particular, esters of acrylic acid and methacrylic acid of formula:

CH₂═CR¹CO₂R²

where R¹ is H or methyl and R² is optionally substituted alkyl of 1 to 20 carbon atoms (more preferably 1 to 8 carbon atoms) or cycloalkyl of 5 to 12 ring carbon atoms. Further specific examples of such monomers include alkyl esters and (chloro)alkyl esters such as methyl α-chloroacrylate, n-propyl α-chloroacrylate, n-butyl α-chloroacrylate, β-chloroethyl acrylate, β-chlorobutyl acrylate, methyl (meth)acrylate, ethyl (meth)acrylate, propyl (meth)acrylate (all isomers), butyl (meth)acrylate (all isomers), isobornyl (meth)acrylate, cyclohexyl (meth)acrylate, 2-ethylhexyl (meth)acrylate, octyl (meth)acrylate, lauryl (meth)acrylate, trifluoroethyl(meth)acrylate, diethyl maleate, diethyl fumarate; vinyl esters such as allyl acetate, ally chloroacetate, methallyl acetate, vinyl acetate, isopmpenyl acetate; vinyl halides such as vinyl chloride, vinylidene chloride, allyl chloride, 1,2-dichloropropene-2, methallyl chloride and trichloroethylene; nitriles such as acrylonitrile and methacrylonitrile; vinyl aryls such as styrene, a-methyl styrene, o-methyl styrene, m-methyl styrene, p-methyl styrene, pentachlorostyrene, o-chlorostyrene, m-chlorostyrene, p-chlorostyrene and p-cyanostyrene; conjugated dienes or chlorodienes such as butadiene and chloroprene; and vinyl-substituted heterocyclic mines such as 2-vinyl-pyridine and vinyl carbazole. Other vinyl monomers include di-hydroxyalkyl (meth)acrylate adducts of organic diisocyanates, such as the di-hydroxyethyl methacrylate adduct of a C₉H₁₈ diisocyanate sold by Rohm GmbH as PLEX 6661.0.

Other monomer(s) (iii) which may also be used to form vinyl polymer A are those bearing a functional group(s) (and not already mentioned above). These can include for example hydroxyl functional monomers such as hydroxyethylacrylate (HEA) and hydroxylethylmethacrylate (HEMA), and olefinically unsaturated amides such as acrylamide, and methacryiamide. The amount of such functional monomer(s) incorporated as part of (iii) is 0 to 20 wt %, preferably 0 to 7 wt %, more preferably 0 to 2 wt % based on total monomer composition to form said at least one vinyl polymer A. In most cases, however, no such functional monomer(s) is used.

Particularly preferred vinyl monomer(s) for (111) are selected from one or more of methyl methacrylate, n-butyl acrylate, n-butyl methacrylate, ethyl acrylate, ethyl methacrylate, 2-ethylhexyl acrylate, styrene, and acrylonitrile.

Preferably 82 to 99.5 wt % of monomer(s) (iii) are used for the provision of a vinyl polymer A, more preferably 89 to 99.2 wt %, and especially 93 to 99 wt %.

The vinyl monomer(s) (i) containing an acid functional group is preferably an olefinically unsaturated monocarboxylic or dicarboxylic acid, examples of which include acrylic acid, methacrylic acid, 2-carboxyethyl acrylate, fumaric acid, maleic acid, itaconic acid, and mono-substituted C₁-C₂₀ alkyl esters of dicarboxylic acids. Monocarboxylic acid(s) is preferred and particularly preferred monomer(s) for (i) are one or both of methacrylic acid and acrylic acid.

Preferably 0.5 to 18 wt % of monomer(s) (i) are used for the provision of a vinyl polymer A, more preferably 0.8 to 11 wt %, especially 1 to 7 wt % and more especially 2 to 5 wt %.

By a carbonyl functional group is meant herein, unless otherwise specified, the carbonyl group of an aldehyde group (aldo) or ketone group (keto) (and includes an enolic carbonyl group such as is found eg in an acetoacetyl group). Preferred carbonyl group containing monomer(s) (ii), if present at all in a vinyl polymer A, are selected from diacetone (meth)acrylamide (DA(M)AM), (meth)acrolein, vinyl alkyl ketones with 1 to 20 C atoms in the alkyl group, and acetoacetoxy ethylmethacrylate (AAEM). Diacetone acrylamide is particularly preferred.

Preferably the amount of carbonyl functional group containing monomer(s) (ii) used for the provision of a vinyl polymer A is 0 to 0.4 wt %. If present at all, the amount is preferably 0.2 to 0.4 wt %. In most cases, however, no carbonyl containing monomer at all is present (0 wt %).

Preferably the monomer composition used for making said at least one vinyl polymer A comprises 29.9 to 79.9 wt % of hard monomers (iii) having a Tg≧80° C. (more preferably ≧90° C.) and 20 to 60 wt % of soft monomers (iii) having a Tg≦20° C. (more preferably ≦10° C.). Preferably hard monomer(s) (iii) of Tg≧80° C. are selected from one or both of methyl methacrylate and styrene and preferably soft monomer(s) (iii) of Tg≦20° C. are selected from one or more of n-butyl acrylate, 2-ethylhexyl acrylate and ethyl acrylate. [For the purposes of the present invention, 2 or more vinyl polymers A in the invention composition which have been prepared using a sequential polymerisation process (i.e. one polymer(s) being formed in the presence of the other(s)) is considered as a single vinyl polymer A as far as Tg calculations are concerned, with the overall monomer composition of the sequential polymers being used as the basis for Tg calculations].

Typically, a vinyl polymer A of the invention composition is formed from 34.5 to 79.5 wt %, more preferably 39.2 to 74.2 wt % and especially from 39 to 69 wt % of one or both of methyl methacrylate and styrene; 20 to 55 wt %, more preferably 25 to 55 wt %, and especially 30 to 55 wt % of one or more of n-butyl acrylate, 2-ethylhexyl acrylate and ethyl acrylate; and 0.5 to 18 wt %, more preferably 0.8 to 11 wt % and especially 1 to 7 wt % of one or both of acrylic acid and methacrylic acid.

The aqueous vinyl polymers can be prepared by any free radical polymerisation method known in the art. Emulsion polymerisation is preferred. The polymers can be prepared using the various polymerisation methods known in the art such as single batch, sequential and gradient polymerisation, also commonly known as a power feed polymerisation. If desired, a preformed or in-situ formed seed can be used.

All commonly used surfactants and initiators can be used. The polymerisation of a monomer composition to form a vinyl polymer A will normally require the use of a free-radical-yielding initiator(s) to initiate the polymerisation. Suitable free-radical-yielding initiators include inorganic peroxides such as K, Na or ammonium persulphate, hydrogen peroxide, or percarbonates; organic peroxides, such as acyl peroxides including for example benzoyl peroxide, alkyl hydroperoxides such as t-butyl hydroperoxide and cumene hydroperoxide; dialkyl peroxides such as di-t-butyl peroxide; peroxy esters such as t-butyl perbenzoate and the like; mixtures may also be used. The peroxy compounds are in some cases advantageously used in combination with suitable reducing agents (redox systems) such as Na or K pyrosulphite or bisulphite, and iso-ascorbic acid. Azo compounds such as azobisisobutyronitrile may also be used. Metal compounds such as Fe.EDTA (EDTA is ethylene diamine tetraacetic acid) may also be usefully employed as part of a redox initiator system. An initiator system partitioning between the aqueous and organic phases, for example a combination of t-butyl hydroperoxide, iso-ascorbic acid and Fe.EDTA, may be of use. The amount of initiator or initiator system to use is conventional, for example within the range 0.05 to 6 wt % based on the total monomer(s) used.

Surfactants can be utilised in order to assist in the dispersion or emulsification of the polymerisaing monomers and the resulting vinyl polymer A in water. Suitable surfactants include but are not limited to conventional anionic, cationic and/or non-ionic surfactants and mixtures thereof such as Na, K and NH₄ salts of dialkylsulphosuccinates, Na, K and NH₄ salts of sulphated oils, Na, K and NH₄ salts of alkyl sulphonic acids, Na, K and NH₄ alkyl sulphates, alkali metal salts of sulphonic acids; fatty alcohols, ethoxylated fatty acids and/or fatty amides, and Na, K and NH₄ salts of fatty acids such as Na stearate and Na oleate. Other anionic surfactants include alkyl or (alk)aryl groups linked to sulphonic acid groups, sulphuric acid half ester groups (linked in turn to polyglycol ether groups), phosphonic acid groups, phosphoric acid analogues and phosphates or carboxylic acid groups. Cationic surfactants include alkyl or (alk)aryl groups linked to quaternary ammonium salt groups. Non-ionic surfactants include polyglycol ether compounds and preferably polyethylene oxide compounds as disclosed in “non-ionic surfactants-Physical chemistry” edited by M. J. Schick, M. Decker 1987. The amount of surfactant used is preferably 0 to 15% by weight, more preferably 0 to 8% by weight, still more preferably 0 to 5% by weight, especially 0.1 to 3% by weight and most especially 0.3 to 2% by weight based on the weight of vinyl polymer A.

The molecular weight Mw of a vinyl polymer A can lowered by using a chain transfer agent (CTA) such as 3-mercapto propionic acid or n-lauryl mercaptane in the polymerisation process. Catalytic chain transfer polymerisation using specific Co chelate catalysts as CTA can also be used to lower Mw. The amount of CTA used is often between from 0 to 10 wt %, preferably between from 0 to 4 wt %, more preferably between from 0 to 2 wt % on total monomer weight.

The glass transition temperature of a vinyl polymer A in this specification is that calculated by means of the Fox equation. Thus the Tg, in degrees Kelvin, of a copolymer having “n” copolymerised comonomers is given by the weight fractions W of each comonomer type and the Tg's of the homopolymers (in degrees Kelvin) derived from each comonomer according to the equation:

$$\frac{1}{Tg} = \frac{{W}_{1}}{{Tg}_{1}} + \frac{{W}_{2}}{{Tg}_{2}} + … \frac{{W}_{n}}{{Tg}_{n}}$$

The calculated Tg in degrees Kelvin may be readily converted to ° C.

In the polymer dispersion of the invention composition, it is preferred that the weight average particle diameter (Dw) (i.e. the particle size, since the particles are considered as essentially spherical) of the polymer particles is within the range of from 30 to 600 nm, more preferably 50 to 300 nm, especially 60 to 250 nm. If vinyl polymer A is alkali soluble the particle size of the particles is preferably measured before the addition, of the alkali.

The solids content of the invention composition is between 20 and 70 wt %, preferably between 30 and 60 wt % and more preferably between 35 and 55 wt %.

By a polyhydrazine compound(s) B (used as component (2) of the invention composition) is meant herein a compound(s) containing at least two hydrazine functional groups (—NH—NH₂) per molecule. Suitable polyhydrazine compounds include polyhydrazides of formula R³(C(═O)—NH—NH₂)ₙ, where R³ is an optionally substituted alkylene, alicyclic, or aryl group, or a polymer chain, and n is from 2 to 10, preferably being 2 or 3 and more particularly 2). Suitable polyhydrazine compounds include but are not limited to dicarboxylic acid dihydrazides examples of which include adipic acid, oxalic acid, malonic acid, maleic acid, fumaric acid, itaconic acid, glutaric acid, pivalic acid, sebacic acid, pimelic acid, suberic acid, azelaic acid, undecanedioic acid, dodecanedioic acid, tridecanedioic acid, tetradecanedioic acid, pentadecanedioic acid, hexadecanedioic acid and 2-methyltetradecanedioic dihydrazide. Other carboxylic acid hydrazides include methyl-, ethyl-, propyl-, butyl-, hexyl-, heptyl-, octyl-, 2-ethylhexyl-, nonyl-, decyl-, undecyl- and dodecylmalonic dihydrazide, methyl-, ethyl-, propyl-, butyl-, hexyl-, heptyl- and octylsuccinic dihydrazide, 2-ethyl-3-propylsuccinic and -glutaric dihydrazide, cyclohexanedicarboxylic and cyclohexylmethylmalonic dihydrazide, terephthalic, phenylsuccinic, cinnamylmalonic and benzylmalonic dihydrazide, pentane-1,3,5-tricarboxylic trihydrazide, hex-4-ene-1,2,6-tricarboxylic trihydrazide, 3-cyanopentane-1,3,5-tricarboxylic trihydrazide and dicyanofumaric dihydrazide, as well as di- and oligohydrazides of dimeric and oligomeric unsaturated fatty acids. Thiohydrazides (R³(—C(═S)—NH—NH₂), where R³ and n are as above) can be used as well.

Polyhydrazides of aromatic polycarboxylic acids, e.g. the dihydrazides of phthalic acid, terephthalic acid and isophthalic acid and the dihydrazides, trihydrazides and tetrahydrazide of pyromellitic acid may also be used.

Examples of other suitable polyhydrazide compounds are polyhydrazides of polyacrylic acids which contain 2 or more hydrazide groups, in most cases 20 to 100 hydrazide groups, per molecule, trihydrazides, e.g. nitrilotriacetic acid trihydrazide, and tetrahydrazides, e.g. ethylenediaminetetraacetic acid tetrahydrazide. Further possible hydrazides are dihydrazine- and trihydrazine-triazine, thiocarbohydrazide and N,N′-diaminoguanidine, as well as hydrazinopyridine derivatives of the type of 2-hydrazino-pyridine-5-carboxylic acid hydrazide, 3-chloro-2-hydrazinopyridine-5-carboxylic acid hydrazide, 6-chloro-2-hydrazinepyridine-4-carboxylic acid hydrazide and 2,5-dihydrazino-4-carboxylic acid hydrazide.

Further suitable compounds are polyhydrazides of carbonic acid, e.g. carbonic acid dihydrazides and compounds of the general formula H₂N—NHC(═O)—(NH—NH—C(═O)—)ₓNH—NH₂, where x is from 1 to 5, preferably 1 to 3.

Other suitable polyhydrazides are aliphatic and cycloaliphatic bis-semicarbazides of the general formula H₂N—NH—C(═O)—NH—R⁴—HN═C(O)—NH—NH₂, where —R⁴— is a straight or branched aliphatic radical of 2 to 14 carbon atoms or a carbocyclic radical of 6 to 14 carbon atoms, e.g. 0-, m- or p-phenylene, toluoylene, cyclohexylidene or methylcyclohexylidene. Also bis-thiocarbazides can be used.

Mixtures of different polyhydrazine compounds B can of course be used as component (2).

Particularly preferred polyhydrazine compounds B are adipic acid dihydrazide and/or succinic acid dihydrazide.

The polyhydrazide compounds mentioned above can in many cases be prepared by known processes such as by hydrazinolysis of carboxylic ester groups of a precursor dicarboxylic acid or ester group-containing oligomer. This and other hydrazinolysis reactions are described in “The Chemistry of Hydrazides,” H. Paulsen and D. Stye, Chapter 10, pp. 515-600 in “The Chemistry of Amides”, H. Zabicky, Ed., Interscience Publishers, New York, N.Y., 1970.

Component (2) of the invention composition preferably comprises preferably 0.05 to 8 wt %, more preferably 0.01 to 6 wt % and particularly 0.2 to 5 wt % of polyhydrazine compound B based on total polymer weight of vinyl polymer A.

The polyhydrazine compound B of component (2) may be incorporated into the invention composition before, during or after the polymerisation to form said at least one vinyl polymer A. Preferably it is incorporated after the polymerisation.

The invention composition (containing vinyl polymer A and polyhydrazine compound B) may if desired also include suitable other polymer(s) which are not according to vinyl polymer A (e.g. by blending polymer latexes) from the point of view of improving the wet adhesion to aged alkyds and adhesion to polyolefine substrates (such as BOPP) of such other polymer(s). Preferably though vinyl polymer A is not blended. The amount of vinyl polymer A in such a blend is preferably ≧50 wt %, more preferably ≧65 wt % and most preferably ≧80 wt %. Such other polymer(s) could e.g. be a vinyl polymer (not according to polymer A), a polyurethane, or a polyester (in the form e.g. of polymer latex which could be blended with the vinyl polymer A containing dispersion or composition containing it). The König hardness of the resultant film must however not fall below 40 seconds on account of the presence of such other polymer(s).

König hardness as used herein is a standard measure of hardness, being a determination of how the viscoelastic properties of a film formed from the composition slows down a swinging motion deforming the surface of the film, and is measured according to DIN 53157 using an Erichsen hardness equipment. Preferably the König hardness of a film of the invention composition is ≧45 seconds, more preferably ≧50 seconds, still more preferably ≧60 seconds, especially ≧70 seconds and most especially ≧90 seconds.

Preferably the aqueous coating composition of the invention provides good wet adhesion to aged alkyd surfaces. Good wet adhesion to aged alkyd surfaces is defined as having a score of 4 or 5 in the wet adhesion test (after 2000 scrubs) as described below.

Preferably the aqueous composition of the invention provides good adhesion to treated polyolefine surfaces. Good adhesion to treated polyolefine surfaces is defined as having a score of <10% in the adhesion test (lift-off) as described below, in an embodiment of the present invention the aqueous coating composition comprises (1) an aqueous dispersion of at least one vinyl polymer A having a Mw of at least 15 kDa and a Tg of at least 0° C., more preferably at least 20° C., wherein said at least one vinyl polymer A is formed from the polymerisation of:
(i) 0.5 to 18 wt %, more preferably 0.8 to 11 wt % and especially 1 to 7 wt % of at least one vinyl monomer containing an acid functional group(s);
(ii) 0 wt % of a vinyl monomer containing a carbonyl functional group(s);
(iii) 99.5 to 82 wt %, more preferably 99.2 to 89 wt %, and especially 93 to 99 wt % of another vinyl monomer(s) not comprised in (i) or (ii);
where (i)+(ii)+(iii) add up to 100 wt %; and
(2) 0.01 to 10 wt %, more preferably 0.05 to 6 wt % and especially 0.1 to 5 wt % of at least one polyhydrazine compound B based on the weight of said at least one vinyl polymer A; and
wherein:
   (a) said composition provides a film coating of König hardness L 40 seconds; and
   (b) said composition provides good wet adhesion to aged alkyd surfaces.

In another embodiment of the present invention the aqueous coating composition comprises (1) an aqueous dispersion of at least one vinyl polymer A having a Mw of at least 15 kDa and a Tg of at least 0° C., more preferably at least 20° C., wherein said at least one vinyl polymer A is formed from the polymerisation of:
(i) 0.5 to 18 wt %, more preferably 0.8 to 11 wt % and especially 1 to 7 wt % of at least one vinyl monomer containing an acid functional group(s);
(ii) 0 wt % of a vinyl monomer containing a carbonyl functional group;
(iii) 99.5 to 82 wt %, more preferably 99.2 to 89 wt %, and especially 93 to 99 wt % of another vinyl monomer(s) not comprised in (i) or (ii);
where (i)+(ii)+(iii) add up to 100 wt %; and
(2) 0.01 to 10 wt %, more preferably 0.05 to 6 wt % and especially 0.1 to 5 wt % of at least one polyhydrazine compound B based on the weight of said at least one vinyl polymer A;
and wherein:
   (a) said composition provides a film coating of König hardness ≧40 seconds; and
   (b) said composition provides good adhesion to treated polyolefine surfaces.

In a further embodiment of the present invention there is provided the use of a composition according to the invention (as defined above) for coating the surface of a polymer substrate, particularly aged alkyd surfaces or treated (preferably corona treated) polyolefine (preferably biaxially oriented polypropylene BOPP) surfaces. Especially in the case of coating BOPP, in a yet further embodiment, the invention composition is used for the provision of a primer coating for a second coating (ie a subsequently applied coating) which is preferably a water-based and/or UV-curing ink.

The aqueous composition of the invention may for example be used, appropriately formulated where necessary, for the provision of films, polishes, varnishes, lacquers, paints, and inks. However, they are particularly useful and suitable for providing the basis of protective coatings for wooden substrates (e.g. wooden floors, window frames), and plastics, paper and metal substrates. Accordingly, a further embodiment of the present invention provides a substrate coated with a composition according to the invention.

A yet further embodiment of the present invention provides a process for the preparation of an aqueous composition according to the invention which has the steps of:
(a) aqueous emulsion polymerising monomers (i) to (iii) to form said at least one polymer A;
(b) before, during or after the polymerisation adding said polyhydrazine compound B, where the amounts of monomer used for polymer(s) A, its Tg and its Mw, and the amount of polyhydrazine compound(s) B used, and the König hardness of the composition, are as defined above.

The aqueous composition of the invention may be used in various applications, and for such purposes may be further optionally combined or formulated with other additives or components (to form compositions), such as defoamers, rheology control agents, thickeners, dispersing and stabilising agents (usually surfactants), wetting agents, fillers, extenders, fungicides, bacteriocides, anti-freeze agents, waxes and pigments.

The compositions once applied may be allowed to dry naturally at ambient temperature, or the drying process may be accelerated by heat.

The present invention is now further illustrated but in no way limited by reference to the following examples. Unless otherwise specified all parts, percentages and ratios are on a weight basis. The prefix C before an example number denotes that it is comparative.

### ABBREVIATIONS USED

S=styrene
MMA=methyl methacrylate
MAA=methacrylic acid
BA=n-butyl acrylate
2-EHA=2-ethylhexyl acrylate
AA=acrylic acid
LMKT=n-lauryl mercaptane
SLS=sodium lauryl sulphate
t-BHPO=t-butyl hydroperoxide
i-AA=iso-ascorbic acid
CTA=chain transfer agent

### Preparation of Polymers 1 to 11

In each preparation a 2 litre three-neck round bottom glass reactor, equipped with a stirrer, nitrogen inlet, thermometer and baffles was loaded with the amounts of reactants listed in Table 1. In a dropping funnel the mixture for emulsified monomer feed was prepared by stirring water and SLS with the monomers according the amounts shown in Table 1 (the feed being kept at ambient temperature). 0.5 wt % ammonium persulphate (on total monomers) was used as initiator in each preparation. The amount of the SLS and its distribution over the reactor phase and monomer feed in each preparation were dictated by the particle sizes that were targeted. The temperature of the reactor phase was raised to 85° C., whereupon the monomer feed was added over a period of 120 minutes. The reaction mixture was kept at 85° C. for 30 minutes followed by cooling to room temperature. If necessary at this stage t-BHPO and i-AA (both 0.1 wt % on monomers) were employed at 85° C. to consume remaining monomers. The pH was adjusted, using a 25% ammonia solution, to about 7-8. Finally the reaction mixture was filtered and collected (in each case as a polymer latex). The specifications of the polymers prepared are also shown in Table 1. All polymers were prepared with a solids content of 40% and with a coagulum below 0.10%.

At the bottom of Table 1 is given the monomer composition in wt % of each preparation.

TABLE 1

| | 1 | 2 | 3 | 4 | 5 | 6 | 7 | 8 | 9 | 10 | 11 |
|---|---|---|---|---|---|---|---|---|---|---|---|
| Polymer | | | | | | | | | | | |
| Reactor phase | | | | | | | | | | | |
| Water | 391.3 | 391.3 | 389.7 | 391.3 | 389.8 | 584.8 | 584.8 | 587.2 | 587.2 | 584.9 | 587.2 |
| SLS | — | — | 2.9 | — | 2.9 | 4.4 | 4.4 | — | — | 4.3 | — |
| Monomer feed | | | | | | | | | | | |
| Water | 188.8 | 185.2 | 184.1 | 188.8 | 184.4 | 276.2 | 276.2 | 283.9 | 283.5 | 276.6 | 283.9 |
| SLS | 10.5 | 15.7 | 16.6 | 10.5 | 16.2 | 24.9 | 24.9 | 14.8 | 15.4 | 24.3 | 14.8 |
| MMA | — | 241.2 | — | 143.7 | — | — | 278.9 | — | — | 352.5 | 398.1 |
| BA | — | 131.0 | — | 230 | — | — | 301.2 | — | — | 191.4 | 186.3 |
| S | 277.2 | — | 252.4 | — | 227.2 | 389.1 | — | 270.5 | 404.2 | — | — |
| 2-EHA | 112.2 | — | 118.8 | — | 143.0 | 167.6 | — | 290.3 | 166.5 | — | — |
| MAA | — | 19.6 | 19.5 | — | — | — | 5.9 | 29.5 | 5.8 | 28.6 | — |
| AA | 3.9 | — | — | 19.7 | 11.5 | 29.3 | — | — | — | — | 5.9 |
| CTA | — | — | — | — | LMKT | — | — | — | LMKT | LMKT | — |
| Tg (° C.) | 40 | 40 | 40 | 0 | 40 | 40 | 10 | 10 | 40 | 40 | 40 |
| Mw (kDa) | 99 | 383 | 177 | 190 | 16 | 141 | 200 | 136 | 31 | 32 | 30 |
| pH | 7.4 | 7.2 | 7.5 | 7.2 | 7.7 | 7.2 | 7.1 | 7.1 | 7.1 | 7.2 | 7.2 |
| Particle size (nm) | 350 | 351 | 87 | 325 | 93 | 1.03 | 92 | 238 | 295 | 84 | 332 |
| Viscosity (mPa · s) | 10 | 9 | 22 | 39 | 51 | 28 | 89 | 22 | 24 | 44 | 16 |
| Monomer (wt %) | | | | | | | | | | | |
| MMA | — | 61.6 | — | 36.5 | — | — | 47.6 | — | — | 61.6 | 67.4 |
| BA | — | 33.4 | — | 58.5 | — | — | 51.4 | — | — | 33.4 | 31.6 |
| S | 70.5 | — | 64.6 | — | 59.5 | 66.4 | — | 45.8 | 70.1 | — | — |
| 2-EHA | 28.5 | — | 30.4 | — | 37.5 | 28.6 | — | 49.2 | 28.9 | — | — |
| MAA | — | 5 | 5 | — | — | — | 1 | 5 | 1 | 5 | — |
| AA | 1 | — | — | 5 | 3 | 3 | — | — | — | — | 1 |

### Preparation of Polymer 12

Two emulsified monomer feeds were prepared. Monomer feed 1 was prepared by mixing water (142.0 g), SLS (7.4 g), ammonium persulphate (1.3 g), MAA (14.8 g), S (190.7 g) and 2-EHA (89.7 g). Monomer feed 2 was prepared by mixing water (142.0 g), SLS (7.4 g), ammonium persulphate (1.3 g), MAA (14.8 g), S (79.2 g) and 2-EHA (201.2 g).

A 2 litre three-neck round bottom glass reactor, equipped with a stirrer, nitrogen inlet, thermometer and baffles was loaded with water (587.2 g) and ammonium persulphate (0.3 g).

The temperature of the reactor phase was raised to 85° C., and monomer feed 1 was added over 120 minutes to the reactor while simultaneously monomer feed 2 was added over a period of 120 minutes to monomer feed 1. After the monomer feeds were completed, the reaction mixture was kept as 85° C. for 30 minutes followed by cooling to room temperature. If necessary at this stage t-BHPO and i-AA (both 0.1 wt % on monomers) were employed at 85° C. to consumer any remaining monomers. The pH was adjusted, using a 25% ammonia solution. Finally the reaction mixture was filtered and collected as a polymer latex. Polymer 12 had a pH of 7.0, a viscosity of 9 mPa·s, a solids content of 40% and was prepared with a coagulum below 1.10%. The particle size was 190 nm and the Mw was 151 kDa and the calculated Tg based on the overall monomer composition (feed 1 and feed 2) was 10° C.

### EXAMPLES 1 TO 11, 14, 15 AND 16

### Paint Formulations

100 g each of the latexes of Polymers 1 to 11 at 40% solids were blended with adipic acid dihydrazide (ADH) according the amounts listed in Table 2 and Table 4, These blends were formulated by adding ethylene diglycol (5 g), Dehydran 1293 (0.3 g) and 49.5 gram of a pigment paste based on rutile TiO₂. The viscosity was adjusted to 4000 to 6000 mPa·s. with a 50% solution of Borchigel L75N,

### EXAMPLE 12

100 g of the latex of Polymer 9 at 40% solids was combined with 3.23 g Hardner SC, a polysemicarbazide compound available from Asahi Kasei (instead of ADH). This blend was formulated by adding ethylene diglycol (5 g), Dehydran 1293 (0.3 g) and 49.5 gram of a pigment paste based on rutile TiO₂. The viscosity was adjusted to 4000-6000 mPa·s. with a 50% solution of Borchigel L75N.

### EXAMPLE 13

100 g of the latex of polymer 12 at 40% solids was combined with ADH (2.79 g). This blend was formulated by adding ethylene diglycol (5 g), Dehydran 1293 (0.3 g) and 49.5 gram of a pigment paste based on rutile TiO₂. The viscosity was adjusted to 4000 to 6000 mPa·s. with a 50% solution of Borchigel L75N.

### COMPARATIVE EXAMPLES C1, C2 and C3

The latexes of Polymers 4 and 11 were formulated as described above without the adipic acid dihydrazide to give comparative examples C1 and C2 respectively (see Table 2). Example 3 of EP 148386 was repeated to give comparative example C3 (see Table 5).

TABLE 2

| Example | Polymer | ADH (g) |
|---|---|---|
| 1 | 1 | 0.8 |
| 2 | 2 | 3.2 |
| 3 | 3 | 3.2 |
| 4 | 4 | 3.9 |
| 5 | 5 | 2.3 |
| 6 | 6 | 3.9 |
| 7 | 7 | 0.7 |
| 8 | 8 | 3.2 |
| 9 | 9 | 0.7 |
| 10 | 10 | 3.2 |
| 11 | 11 | 0.8 |
| 13 | 12 | 2.8 |
| C1 | 4 | — |
| C2 | 11 | — |

### Test Methods for Aged Alkyd Substrate

### (i) Wet Adhesion Test

Metal panels were coated with an alkyd primer (Schakelverf, available from Sigma) and aged over 14 days at 23° C. The formulated paint compositions of Examples 1 to 11 and C1 and C2 were applied onto aged alkyd panels using a 120 μm applicator and dried for 1 hour at room temperature followed by 16 hours at 50° C. One half of each coated panels was sanded (3M Fre-cut sandpaper (P220)). In both halves cross-cuts were made using a standard knife resulting in 1 cm² squares. The panel was placed under an Erichsen™ scrub tester and subjected to a scrub test using 15 cm³ of the scrub medium, The scrub medium was 1 part of Reworyl™ NKS (available from Goldschmidt, Germany) in 200 parts of water. After each set of 500 scrubs, 15 cm³ of scrub medium was applied. After 2000 scrubs (or earlier if the coating had been removed) the level of adhesion was rated from 0 to 5 (0, >65% of the coating was removed; 1, 36 to 65% of the coating was removed; 2, 16 to 35% of the coating was removed; 3, 6 to 15% of the coating was removed; 4, 1 to 5% of the coating was removed; 5 coating completely intact). If the coating was intact after the scrub test, it was dried and subjected to a tape test according to DIN 53151. The tape was attached to the coated alkyd panel with high finger pressure and the tape was removed with high speed. If after 2000 scrubs or earlier the coating was removed (either rating 0 or 1), no tape test was done. The numbers given represent the percentage of coating that was lifted off after the tape (Sellotape™ 1109 with a width of 25 mm) was removed. After the tape test the level of wet adhesion was again rated from 0 (>65% of the coating was removed) to 5 (coating completely intact).

Therefore preferably only 0 to 5% of the aqueous coating composition of the invention when coated onto an alkyd surface aged for 14 days at 23° C. is removed after 2000 scrubs.

### (ii) Water Resistance

On a Leneta™ chart a 100 μm wet film was cast from the paints of Examples 1 to 11 and C1 and C2. The films were dried 4 hours at room temperature followed by 16 hours at 52° C. After being allowed to cool to room temperature a cotton cloth soaked with demineralised water was placed on top of the films and covered by a small petri dish. This was left for 16 hours. After the water and cloth was removed the film appearance was assessed visually. The effect of the water was rated from 0 (film removed) to 5 (no visual damage visible) and—=not measured.

TABLE 3

| | Number of | level of wet | Tape | Water |
|---|---|---|---|---|
| Example | scrubs | adhesion | test | resistance |
| 1 | 2000 | 5 | 0 | 5 |
| 2 | 2000 | 5 | 0 | 5 |
| 3 | 2000 | 1 | — | 4 |
| 4 | 2000 | 0 | — | 5 |
| 5 | 2000 | 5 | 5 | 4 |
| 6 | 2000 | 0 | — | 5 |
| 7 | 2000 | 5 | 5 | 3 |
| 8 | 2000 | 5 | 5 | 4 |
| 9 | 2000 | 5 | 5 | 5 |
| 10 | 2000 | 5 | 4 | 5 |
| 11 | 2000 | 5 | 5 | 4 |
| 12 | 2000 | 5 | 2 | 4 |
| 13 | 2000 | 4 | 4 | 4 |
| C1 | 200 | 0 | — | 5 |
| C2 | 300 | 0 | — | 5 |

The results in Table 3 shows that, compared to when no ADH was present (C1 and C2), the addition of ADH had a very positive effect on the adhesion to aged alkyd (even in Examples 3 and 6, 2000 scrubs could be performed, whereas in C1 and C2 no more than 300 scrubs could be carried out). In addition the water resistance was not compromised, Furthermore, Table 3 also shows that a polysemicarbazide compound (Example 12) also gives an improvement in wet adhesion to aged alkyd surfaces.

### EXAMPLES 14 TO 16

In these examples the effect of using less polyhydrazide (ADH) on polymer 8 on the wet adhesion to alkyd primer (Schakeiverf, available from Sigma) aged over 14 days at 23° C., was investigated, the results being shown in Table 4.

TABLE 4

| | | Number of scrubs/ | Tape | Water |
|---|---|---|---|---|
| Example | ADH (g) | level of wet adhesion | test | resistance |
| 14 | 0.6 | 2000/5 | 5 | 5 |
| 15 | 1.3 | 2000/5 | 1 | 4 |
| 16 | 2.6 | 2000/5 | 3 | 4 |

Table 4 shows that the level of wet adhesion to aged alkyd is high even when the amount of ADH is reduced.

### Blocking Testing

The blocking properties were determined by casting the formulated polymer compositions onto Leneta Charts (120 wet) and allowing the films to dry for 1 hour at ambient temperature followed by 16 hours at 52° C. The films were cut as 3.5×3.5 cm pieces that were placed with the coated sides on top of each other. These were placed in a block tester and a pressure of 1 kg/cm² was applied for 4 hours at a temperature of 52° C. After the coating pieces were removed from the holder they were taken apart and the damage was assessed visually and rated from 5 (=no visual damage) to 0 (=coated pieces do not detach). The results are shown in Table 5.

### Hardness Testing

The König hardness was determined by casting the formulated polymer compositions as films onto glass plates (80 μm wet) and allowing the films to dry for 1 hour at ambient temperature and 16 hours at 52° C. Table 5 below shows these results.

TABLE 5

| | | König hardness |
|---|---|---|
| Example | Block resistance | (seconds) |
| 1 | 3 | 104 |
| 2 | 5 | 91 |
| 3 | 2 | 140 |
| 4 | 2 | 41 |
| 5 | 2 | 59 |
| 6 | 3 | 119 |
| 7 | 2 | 50 |
| 8 | 2 | 50 |
| 9 | 2 | 71 |
| 10 | 2 | 130 |
| 11 | 5 | 60 |
| 12 | 3 | 170 |
| 13 | 4 | 45 |
| 14 | 2 | 51 |
| 15 | 2 | 51 |
| 16 | 2 | 50 |
| C3 | 0 | 30 |

Table 5 shows that the polymers according the invention are much harder and possess superior block resistance compared to C3. This indicates that the polymers according to EP 148386 are not useful for coating applications.

### Test Methods for Adhesion to BOPP

For this test biaxially oriented polypropylene (BOPP) substrate, 50 micron thick as supplied by Innovia Films was used. The BOPP substrate was corona treated with a Vetaphone ET-1, at a line speed of 10 m/min using 325 W.

The latexes of Polymers 1 to 12 were formulated with 0.4 wt % of amorphous silica and diluted to a final solids content of 15 wt %. The formulations were applied to the BOPP eight of 1 g/m². The speed of the film coating was set at 10 m/minute and the coated films were dried at 98° C. for about 10 seconds. The adhesion of the composition of the invention to BOPP was tested by a tape test according to DIN 53151.

Therefore preferably <10% and more preferably <8% of the aqueous coating composition of the invention when coated onto a treated polyolefine surface is removed during the tape test (DIN 53151).

The adhesion of ink to BOPP primed with the polymers according to the invention was checked. The ink used was a commercially available UV-hardening ink (Combination white) that was cured twice at 250 mJ/cm² using a 420 nm UV lamp 24 hours before testing the adhesion. The adhesion of UV-curing ink to BOPP primed with the polymers according to the invention was tested according to DIN 53151. The results are listed in Table 6.

TABLE 6

| | Adhesion to BOPP | Adhesion of ink |
|---|---|---|
| Polymer | (% of lift-off) | (% of lift-off) |
| 1 | 0 | 0 |
| 2 | 0 | 0 |
| 3 | 0 | 0 |
| 6 | 0 | 0 |
| 7 | 0 | 0 |
| 8 | 0 | 0 |
| 9 | 0 | 0 |
| 10 | 0 | 0 |
| 11 | 0 | 5 |
| 12 | 0 | Not measured |
| C1 | 90 | 100 |
| C2 | 0 | 100 |

Table 6 shows that the compositions according the invention showed improved adhesion to BOPP, and the adhesion of inks to BOPP primed with invention compositions was also improved.

1. Aqueous coating composition comprising:
(1) an aqueous dispersion of at least one vinyl polymer A having weight average molecular weight (Mw) of at least 15 kDa and Tg of at least 10° C., wherein said at least one vinyl polymer A has an empirical relationship Tg+Mw≧55, and wherein said at least one vinyl polymer A is formed from the polymerisation of:
(i) 0.1 to 20 wt % of at least one vinyl monomer containing an acid functional group(s);
(ii) 0 to 0.49 wt % of at least one vinyl monomer containing a carbonyl functional group(s); and
(iii) 99.9 to 80 wt % of another vinyl monomer(s) not comprised in (i) or (ii);
where (i)+(ii)+(iii) add up to 100 wt %; and
(2) 0.01 to 10 wt % of at least one polyhydrazine compound B based on the weight of said at least one vinyl polymer A;
and wherein:
(a) said composition provides a film coating of König hardness 40 seconds; and
(b) the carbonyl functional groups in said composition, if any, are provided only by way of said monomer(s) of (ii).

2. Aqueous coating composition comprising:
(1) an aqueous dispersion of at least one vinyl polymer A having weight average molecular weight (Mw) of at least 15 kDa and Tg of at least 10° C., wherein said at least one vinyl polymer A has an empirical relationship Tg+Mw≧55, and wherein said at least one vinyl polymer A is formed from the polymerisation of:
(i) 0.1 to 20 wt % of at least one vinyl monomer containing an acid functional group(s);
(ii) 0 to 0.49 wt % of at least one vinyl monomer containing a carbonyl functional group(s); and
(iii) 99.9 to 80 wt % of another vinyl monomer(s) not comprised in (i) or (ii); where (i)+(ii)+(iii) add up to 100 wt %; and
(2) 0.01 to 10 wt % of at least one polyhydrazine compound B based on the weight of said at least one vinyl polymer A;
and wherein:
(a) said composition provides a film coating of König hardness 40 seconds; and
(b) said composition provides good wet adhesion to aged alkyd surfaces.

3. Aqueous coating composition comprising:
(1) an aqueous dispersion of at least one vinyl polymer A having weight average molecular weight (Mw) of at least 15 kDa and Tg of at least 10° C., wherein said at least one vinyl polymer A has an empirical relationship Tg+Mw≧55, and wherein said at least one vinyl polymer A is formed from the polymerisation of:
(i) 0.1 to 20 wt % of at least one vinyl monomer containing an acid functional group(s);
(ii) 0 to 0.49 wt % of at least one vinyl monomer containing a carbonyl functional group(s); and
(iii) 99.9 to 80 wt % of another vinyl monomer(s) not comprised in (i) or (ii);
where (i)+(ii)+(iii) add up to 100 wt %; and
(2) 0.01 to 10 wt % of at least one polyhydrazine compound B based on the weight of said at least one vinyl polymer A;
and wherein:
(a) said composition provides a film coating of König hardness 40 seconds; and
(b) said composition provides good adhesion to treated polyolefin surfaces.

4. Aqueous coating composition according to claim 1 wherein said at least one vinyl polymer A of said aqueous dispersion (1) is formed from the polymerisation of:
(i) 0.5 to 18 wt % of at least one vinyl monomer containing an acid functional group(s);
(ii) 0 wt % of a vinyl monomer containing a carbonyl functional group(s);
(iii) 99.5 to 82 wt % of another vinyl monomer(s) not comprised in (i) or (ii);
where (i)+(ii)+(iii) add up to 100 wt %; and wherein
said composition provides good wet adhesion to aged alkyd surfaces.

5. Aqueous coating composition according to claim 1 wherein said at least one vinyl polymer A of said aqueous dispersion (1) is formed from the polymerisation of:
(i) 0.5 to 18 wt % of at least one vinyl monomer containing an acid functional group(s);
(ii) 0 wt % of a vinyl monomer containing a carbonyl functional group;
(iii) 99.5 to 82 wt % of another vinyl monomer(s) not comprised in (i) or (ii);
where (i)+(ii)+(iii) add up to 100 wt %; and wherein
said composition provides good adhesion to treated polyolefin surfaces.

6. Aqueous coating composition according to claim 1 wherein said composition provides a film coating of König hardness 45 seconds.

7. Aqueous coating composition according to claim 1 wherein said vinyl monomer (i) contains an acid functional group selected from one or both of acrylic acid and methacrylic acid.

8. Aqueous coating composition according to claim 1 wherein said vinyl monomer (ii) is selected from the group consisting of diacetone (meth)acrylamide, (meth)acrolein, vinyl alkyl ketone with 1 to 20 carbon atoms in the alkyl group, and acetoacetoxy ethylmethacrylate.

9. Aqueous coating composition according to claim 1 wherein said vinyl monomer(s) (iii) is selected from the group consisting of methyl methacrylate, n-butyl acrylate, n-butyl methacrylate, ethyl acrylate, ethyl methacrylate, 2-ethylhexyl acrylate, styrene and acrylonitrile.

10. Aqueous coating composition according to claim 1 wherein the vinyl monomer composition used for making said at least one vinyl polymer A comprises 29.9 to 79.9 wt % of hard vinyl monomers (iii) having a Tg≧80° C. and 20 to 60 wt % of soft vinyl monomers (iii) having a Tg≧5, 20° C.

11. Aqueous coating composition according to claim 10 wherein said hard vinyl monomer(s) (iii) of Tg≧80° C. are selected from one or both of methyl methacrylate and styrene.

12. Aqueous coating composition according to claim 10 wherein said soft vinyl monomer(s) (iii) of Tg≧20° C. are selected from one or more of n-butyl acrylate, 2-ethylhexyl acrylate and ethyl acrylate.

13. Aqueous coating composition according to claim 1 wherein said at least one vinyl polymer A is formed from 34.5 to 79.5 wt % of one or both of methyl methacrylate and styrene, 20 to 55 wt % of one or more of n-butyl acrylate, 2-ethylhexyl acrylate and ethyl acrylate and 0.8 to 11 wt % of one or both of acrylic acid and methacrylic acid.

14. Aqueous coating composition according to claim 1 wherein the polyhydrazine compound(s) B used for component (2) is adipic acid dihydrazide and/or succinic acid dihydrazide.

15. Aqueous coating composition according to claim 1 which has an average particle size within the range of from 30 to 600 nm.

16. A polymer substrate which comprises a surface coated with the composition according to claim 1.

17. A polymer substrate comprising an aged alkyd surface coated with the composition according to claim 1.

18. A polyolefin substrate comprising a surface coated with the composition according to claim 1.

19. Process for the preparation of an aqueous coating composition according to claim 1 comprising the steps of:
(a) aqueous emulsion polymerising monomers (i) to (iii) to form said at least one polymer A; and
(b) before, during or after the polymerisation adding said at least one polyhydrazine compound B.
